(19) United States
(12) Patent Application Publication
(10) Pub. No.: US 2011/0254777 A1
(43) Pub. Date: Oct. 20, 2011

(54) INTERFACE DEVICE AND METHODS OF USING SAME

(76) Inventor: IAN DOUGLAS CAMPBELL, Smyrna, GA (US)

(21) Appl. No.: 12/763,916

(22) Filed: Apr. 20, 2010

(51) Int. Cl. G06F 3/041; G06F 19/00; G01L 1/00

(52) U.S. Cl. 345/173; 702/41; 702/150

(57) ABSTRACT

An interface device for measuring a force applied by a user is disclosed. In one aspect, the interface device has a deformable body positioned on a support housing. In another aspect, the deformable body contains a fluid medium. The interface device also has at least one pressure sensor in fluid communication with the fluid medium. In an additional aspect, the interface device has processing circuitry for receiving pressure signals from the pressure sensors and producing an output signal corresponding to the force applied by the user.

### FIELD OF THE INVENTION

This invention relates to an interface device and, more specifically, to an interface device for measuring an applied force and producing an output signal.

### BACKGROUND OF THE INVENTION

A variety of known interface devices permit interaction between a user and external devices, such as personal computers. These known interface devices, such as conventional computer mouse devices, are moveable by a user to selectively alter the appearance of a display associated with an external device. For example, a conventional computer mouse can be moved to control the two-dimensional position of a cursor graphically depicted on a computer monitor display. Known interface devices also have one or more elements for receiving an action by the user and communicating the action to an external device. For example, a conventional computer mouse has buttons that can be pressed by a user to select an icon or other graphic depicted on a computer monitor display. However, the elements for receiving user actions in known interface devices are only capable of receiving and recognizing binary actions in which only two user responses are possible, such as “on/off” or “yes/no.” Thus, known interface devices are incapable of receiving and recognizing non-binary actions in which user responses within a continuous range of options are possible. Additionally, known interface devices are only capable of tolerating a small force from the user before the known interface devices are damaged or the user is injured due to the rigid nature of the interface devices.

Accordingly, there is a need in the pertinent art for an interface device that is capable of receiving and recognizing a range of user actions. There is also a need in the pertinent art for an interface device that is capable of tolerating a force from a user without being damaged or causing injury to the user.

### SUMMARY

Described herein is an interface device for measuring a force applied by a user. In one aspect, the interface device comprises a deformable body positioned on a support housing. In another aspect, the deformable body contains a fluid medium. The interface device also comprises at least one pressure sensor in fluid communication with the fluid medium. The pressure sensor generates a pressure signal in response to the application of the force to the deformable body. In an additional aspect, the interface device comprises processing circuitry for receiving pressure signals from the pressure sensor and producing an output signal corresponding to the force applied by the user. In use, the interface device is configured to communicate with one or more external devices, including computers and gaming consoles.

### DETAILED DESCRIPTION OF THE FIGURES

These and other features of the preferred embodiments of the invention will become more apparent in the detailed description in which reference is made to the appended drawings wherein:

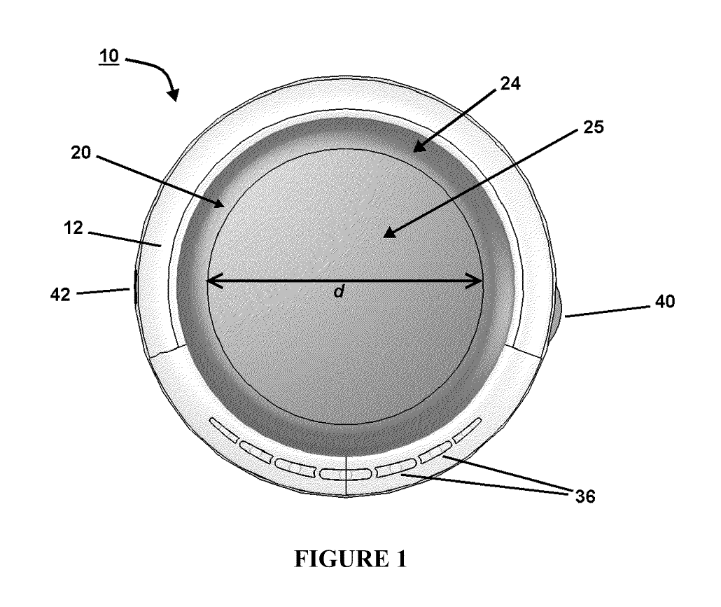

FIG. 1 is a top view of an exemplary interface device as described herein.

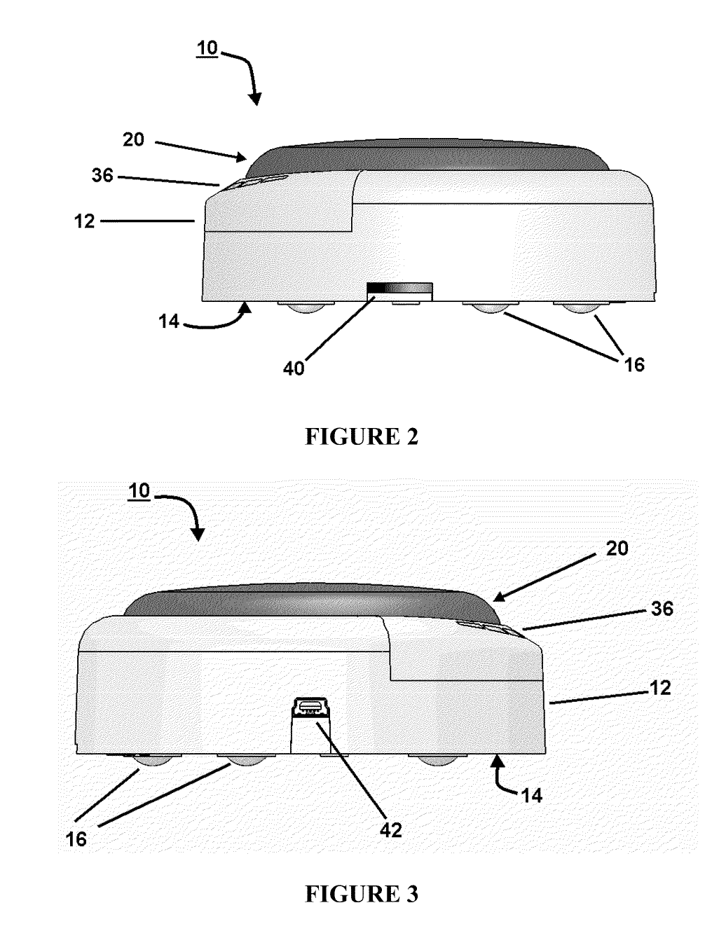

FIG. 2 is a right side view of the interface device of FIG. 1.

FIG. 3 is a left side view of the interface device of FIG. 1.

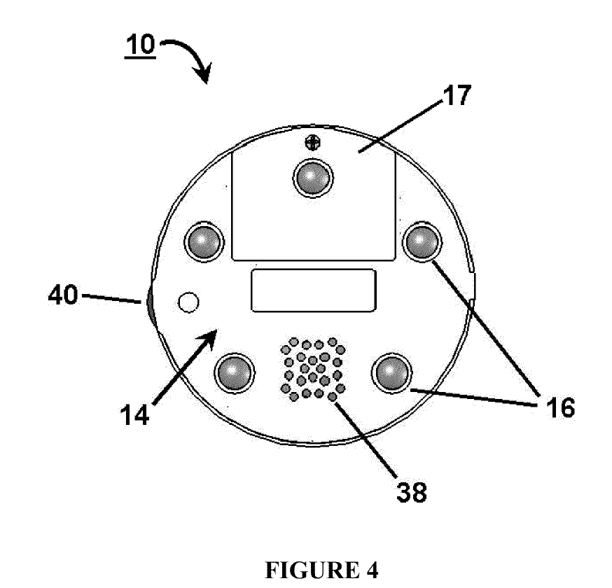

FIG. 4 is a bottom view of the interface device of FIG. 1.

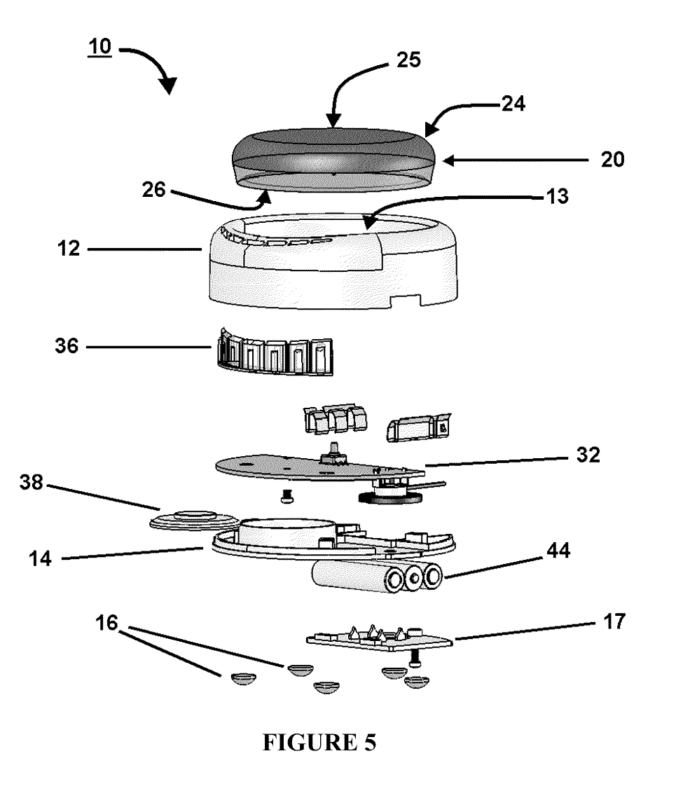

FIG. 5 is an exploded perspective view the interface device of FIG. 1.

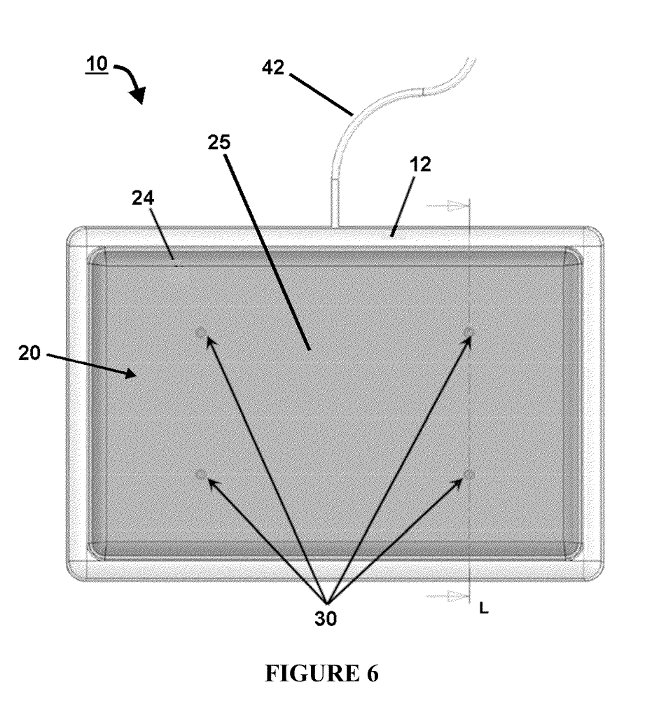

FIG. 6 is a top view of another exemplary interface device as described herein.

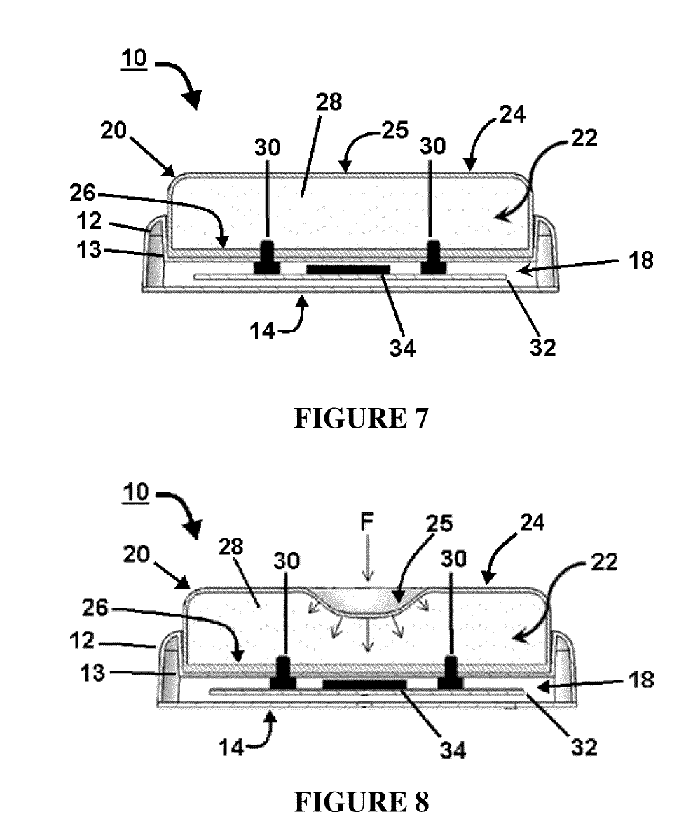

FIG. 7 is a cross-sectional view of the interface device of FIG. 6 along line L.

FIG. 8 is a cross-sectional view of the interface device of FIG. 6 along line L following the application of force F to the interface device.

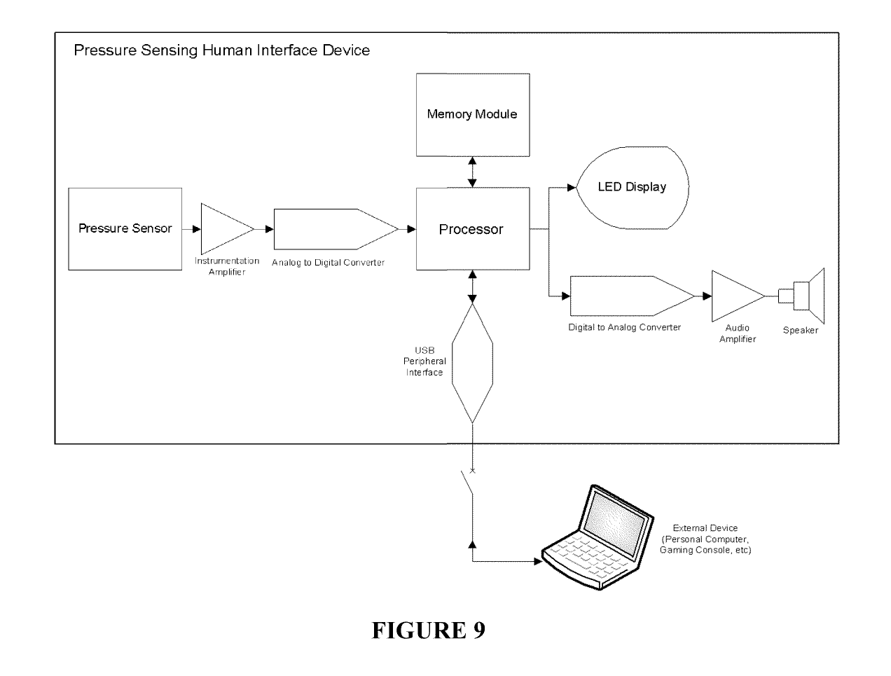

FIG. 9 is a schematic diagram depicting the electrical communications within the processing circuitry of the interface devices as described herein.

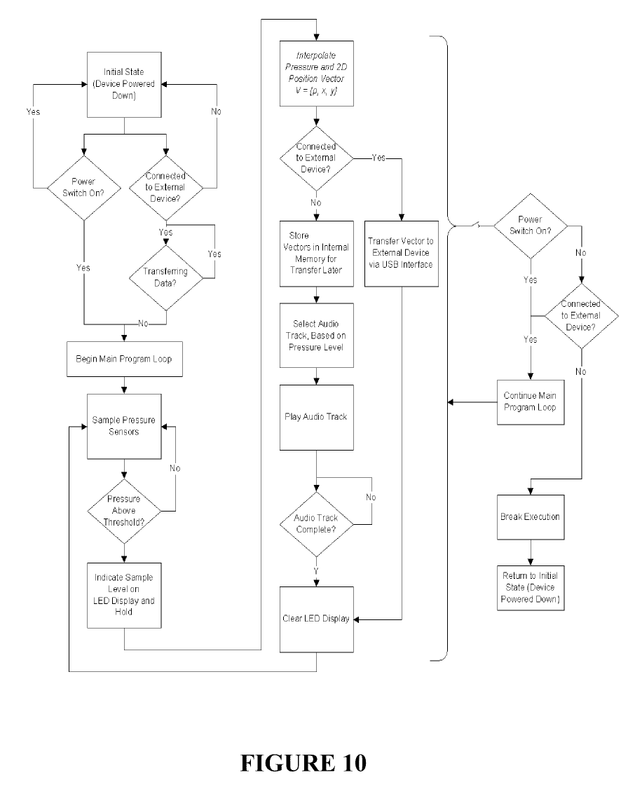

FIG. 10 is a schematic diagram depicting the steps undertaken by the processing circuitry during operation of the interface devices as described herein.

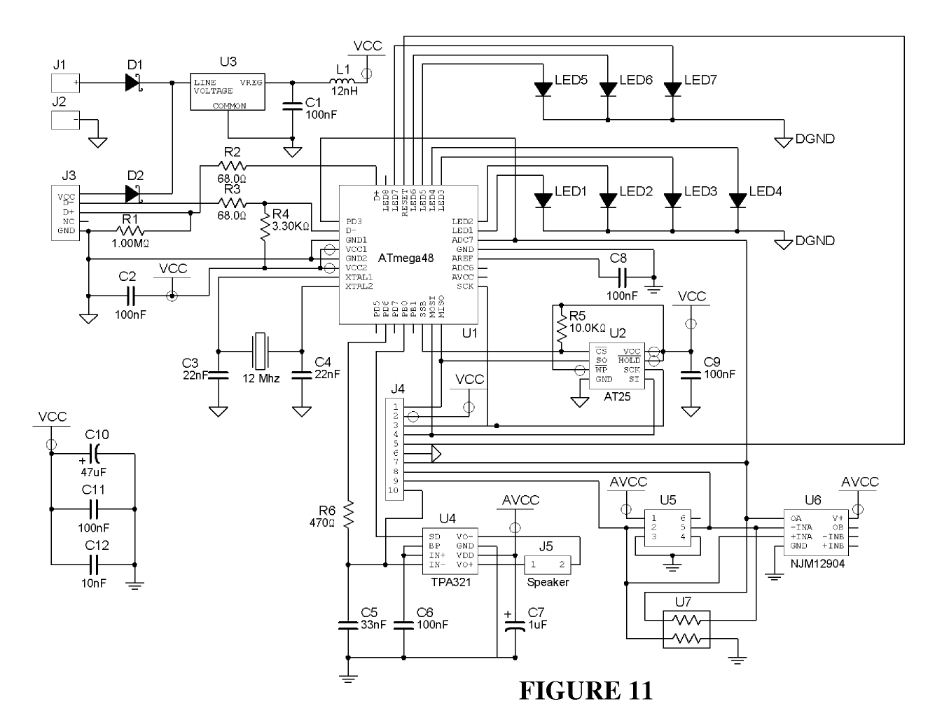

FIG. 11 is a schematic diagram depicting an exemplary arrangement of the processing circuitry of the interface devices as described herein.

### DETAILED DESCRIPTION OF THE INVENTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a pressure sensor” can include two or more such pressure sensors unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

In one embodiment, the invention relates to an interface device for measuring a force applied to at least a portion thereof. In one aspect, as depicted in FIGS. 1-8, the interface device 10 comprises a support housing 12 formed of a substantially rigid material, such as, for example and without limitation, plastic. It is contemplated that the support housing 12 can comprise acrylonitirile butadiene styrene plastic. In an additional aspect, the support housing 12 can have a bottom surface 14. In this aspect, at least one bumper 16 can be attached to the bottom surface 14 of the support housing 12. In a further aspect, and with reference to FIGS. 7 and 8, the support housing 12 can define an inner chamber 18.

In another aspect, the interface device comprises a body 20 positioned on the support housing 12, the body being deformable along at least a portion thereof. In an additional aspect, the deformable portion of the body 20 can define a central chamber 22. In a further aspect, the body 20 can comprise an outer surface 24 and an opposed, base surface 26, with the outer surface of the body defining thereon a contact surface 25 for receiving the force F. It is contemplated that the deformable portion of the body 20 can be configured to substantially recover its shape upon removal of the force F from the contact surface 25. It is further contemplated that the contact surface 25 can be shaped to receive a portion of a human body, such as, for example and without limitation, a human hand or foot. In one aspect, the contact surface 25 can have a substantially circular shape as depicted in FIGS. 1-5. However, it is contemplated that the contact surface 25 can have any shape, such as, for example and without limitation, a substantially square shape, a substantially rectangular shape as depicted in FIGS. 6-8, a substantially elliptical shape, and the like. In a further aspect, and with reference to FIG. 1, the contact surface 25 of the body 20 can have a diameter d ranging from about 50 mm to about 200 mm, more preferably from about 75 mm to about 150 mm.

In another aspect, the outer surface 24 of the body 20 can comprise a woven fabric. In this aspect, the outer surface 24 of the body 20 can comprise a woven synthetic fabric, such as, for example and without limitation, a polyester fabric, an aramid fabric, a nylon fabric, and the like. It is also contemplated that the outer surface 24 of the body 20 can comprise natural fibers, such as, for example and without limitation, cotton and silk. In a further aspect, the outer surface 24 of the body 20 can comprise at least one of spandex, elastane, and polyurethane-polyurea copolymers as are conventionally known in the pertinent art, including, for example and without limitation, Lycra® fibers manufactured by INVISTA, Inc. In an additional aspect, the base surface 26 of the body 20 can comprise silicone. In this aspect, the outer surface 24 can comprise silicone rubber having a Shore A durometer ranging from about 10 to about 70.

In a further aspect, the body 20 can comprise a fluid medium 28 which can be disposed within the central chamber 22 of the body. It is contemplated that the fluid medium 28 can comprise a gelatinous material, such as, for example and without limitation, silicone gel. It is further contemplated that the gelatinous material can have a desired viscosity ranging from about 1 milliPascal-second to about 500 milliPascal-seconds, more preferably from about 10 milliPascal-seconds to about 400 milliPascal-seconds, and most preferably from about 100 milliPascal-seconds to about 200 milliPascal-seconds. In another aspect, the gelatinous material can have a desired durometer ranging from about 1 to about 30, more preferably from about 2 to about 25, and most preferably from about 5 to about 20, as measured on the 0 to 100 scale of a PTC Model 302 SL Hardness Tester manufactured by Pacific Transducer Corporation.

In an additional aspect, the interface device 10 can comprise at least one pressure sensor 30 in communication with the fluid medium 28 and configured to produce a pressure signal which is indicative of the pressure created by application of the force F upon the contact surface 25. It is further contemplated that the pressure signal can be an analog signal. In one aspect, the at least one pressure sensor 30 can be a piezoelectric strain gauge pressure sensor and, in particular, can be a Wheatstone bridge piezoelectric strain gauge pressure sensor. In another aspect, each sensor 30 of the at least one pressure sensor can have a desired resolution, which corresponds to the smallest change in pressure that can be detected by each sensor. In this aspect, the desired resolution of each sensor 30 can be less than about 70 kiliPascals.

In one aspect, the at least one pressure sensor 30 can be positioned within the inner chamber 18 of the support housing 12. In a further aspect, at least a portion of each pressure sensor 30 of the at least one pressure sensor can be disposed within the central chamber 22 of the body 20 such that each pressure sensor is in communication with the fluid medium 28. In this aspect, it is contemplated that the outer surface 24 of the body 20 can define a plurality of openings. It is further contemplated that at least one pressure sensor 30 of the plurality of pressure sensors can be received within an opening of the plurality of openings in the outer surface 24 of the body 20. In still a further aspect, and with reference to FIG. 8, the pressure sensors 30 of the at least one pressure sensor can be spaced such that the at least one pressure sensor can detect the origin and magnitude of the force F applied to the contact surface 25 and does not engage with any surface of the body 20 upon application of the force to the contact surface. For example, it is contemplated that the pressure sensors of the at least one pressure sensor can be spaced from the contact surface such that the contact surface of the body will not contact the at least one pressure sensor upon application of the force. As one having ordinary skill in the art will appreciate, this spacing of the at least one pressure sensor ensures that users of the interface device are not injured during application of large forces to the contact surface of the body.

In one aspect, the interface device 10 can comprise processing circuitry 32 configured to receive the pressure signal from the at least one pressure signal to produce an output signal resulting from the processing of the pressure signal. It is further contemplated that the output signal can be a digital signal. In an additional aspect, and with reference to FIGS. 5, 7, and 8, the processing circuitry 32 can be positioned on a printed circuit board. In a further aspect, the processing circuitry 32 can be positioned within the inner chamber 18 of the support housing 12. Alternatively, the processing circuitry 32 can be positioned external to the support housing 12.

In another aspect, the interface device 10 can comprise means for communicating the pressure signal from the at least one pressure sensor 30 to the processing circuitry 32. In this aspect, it is contemplated that the means for communicating the pressure signal can comprise any conventional electrical communication mechanism, such as, for example and without limitation, electrical wiring, electrical cables, optical fibers, an infrared transmitter such as a conventional remote control, and a conventional wireless transmitter.

In a further aspect, the support housing 12 can have a recessed portion 13 as depicted in FIGS. 5, 7, and 8. In this aspect, at least a portion of the body 20 can be positioned within the recessed portion 13 of the support housing 12. For example, it is contemplated that upon positioning of a portion of the body 20 within the recessed portion 13, the contact surface 25 of the body 20 can be spaced from the support housing 12 such that a user can apply a force to the contact surface without physically impacting the support housing.

In one aspect, and with reference to FIGS. 9-10, the processing circuitry 32 can comprise means for calculating the force F applied to the contact surface 25 of the body 20. In another aspect, the processing circuitry 32 can comprise an instrumentation amplifier for amplifying the pressure signal. In an additional aspect, the processing circuitry 32 can comprise a conventional analog/digital converter for digitally converting the pressure signal of the at least one pressure sensor 30.

In another aspect, and with reference to FIGS. 7-10, the processing circuitry 32 can comprise a processor 34. In this aspect, it is contemplated that the force F can be applied at an origin position relative to the contact surface 25 of the body 20. It is further contemplated that the processor 34 can be configured to identify the origin position of the force F to thereby produce one or more output signals, such as a single output signal or an array of output signals, corresponding to the pressure signals measured by the at least one pressure sensor 30. In this aspect, each output signal can comprise an integer indicative of the magnitude of the force F applied to the contact surface 25. For example, and without limitation, the integers comprising the output signal can range from 0 to 255, with 0 representing the lowest possible magnitude of the applied force and 255 representing the greatest possible magnitude of the applied force. In still a further aspect, the processor 34 can be configured to calculate two-dimensional coordinates corresponding to the origin position of the force F relative to the contact surface 25 of the body 20. In yet another aspect, it is contemplated that the output signals can be digital. In this aspect, it is contemplated that the processing circuitry 32 can optionally comprise a digital/analog converter for converting the digital output signals into an analog signal. A diagram of exemplary processing circuitry is provided in FIG. 11.

In operation, when no force is applied to the contact surface 25 of the body 20, it is contemplated that the fluid medium 28 disposed within the central chamber 22 of the body 20 will be at rest at a constant pressure, and, consequently, the at least one pressure sensor 30 will not sense any pressure differential. When the force F is applied to the contact surface 25, it is contemplated that a pressure gradient centered at the origin position will develop within the fluid medium 28 as depicted in FIG. 8. The at least one pressure sensor 30 can detect this pressure gradient within the fluid medium 28 and report the pressure signal through the processing circuitry 32 to the processor 34. Using the pressure differentials detected by each pressure sensor 30 of the at least one pressure sensor, the processor 34 can produce the output signal by calculating both the intensity of the force F applied to the contact surface 25 and the origin position of the force relative to the contact surface. It is contemplated that the processor 34 can be configured to produce the output signal as a vector of maximum pressure within the fluid medium 28 of the body 20, as well as the two-dimensional coordinates corresponding to the origin position of the force F relative to the contact surface 25. For example, a vector of these results can be represented as V={ρ, x, y}, where V is the results vector, ρ is the maximum pressure observed by the at least one pressure sensor, and x and y are the two-dimensional coordinates corresponding to the origin position of the force relative to the contact surface.

Optionally, in an additional aspect, the interface device 10 can further comprise visual display means 36 which can be in electrical communication with the processing circuitry 32. In a further aspect, the visual display means 36 can be configured to display the output signal of the at least one pressure sensor 30. It is contemplated that the visual display means 36 can be positioned external to the support housing 12. Alternatively, the visual display means 36 can be attached to an external surface of the support housing 12. It is further contemplated that the visual display means 36 can comprise any conventional electrical display, such as, for example and without limitation, a single light emitting diode (LED's), a one-dimensional array of LED's, a two-dimensional array of LED's, a liquid crystal display (LCD), or a conventional display monitor.

In another aspect, the interface device 10 can optionally comprise sound generating means 38 which can be in electrical communication with the processing circuitry 32. In an additional aspect, the sound generating means 38 can be configured to generate an audible response corresponding to the output signal of the at least one pressure sensor 30. It is contemplated that the sound generating means 38 can be positioned external to the support housing 12. Alternatively, the sound generating means 38 can be positioned within the inner chamber 18 of the support housing 12. In a further aspect, the sound generating means 38 can comprise an amplifier. In still a further aspect, the sound generating means 38 can comprise at least one of a speaker and a buzzer. In another aspect, the sound generating means 38 can comprise volume adjustment controls 40 for adjusting the level of sound of the audible response.

In an additional aspect, the interface device can optionally comprise a memory. In this aspect, the memory can be in electrical communication with the processing circuitry 32, and configured to store at least one of the following: selected output signals of the at least one pressure sensor; audible response data; device configuration data; and device performance data. It is contemplated that the audible response data stored on the memory can comprise one or more audio tracks. It is further contemplated that the device configuration data can comprise information regarding user-controlled performance specifications. It is still further contemplated that the device performance data stored on the memory can comprise information regarding the performance of the interface device 10. In another aspect, the memory can be configured to store timestamp values corresponding to the time at which an output signal was generated. In yet another aspect, the memory can be configured to store device identification information, such as, for example and without limitation, at least one of a serial number and a manufacturing batch number of the interface device 10.

In a further aspect, the processing circuitry 32 of the interface device 10 can comprise means for transmitting information to, and receiving information from, one or more external devices. In this aspect, the means for transmitting information 42 can be configured to transmit selected output signals of the at least one pressure sensor 30 to the one or more external devices. In an additional aspect, and with reference to FIGS. 9 and 10, the one or more external devices can comprise at least one of a personal computer and a conventional gaming console. In another aspect, the one or more external devices can comprise a measurement console configured to display output signals transmitted by the interface device 10. In this aspect, it is contemplated that the measurement console can be configured to collect and display information corresponding to output signals generated during an orthopedic rehabilitation test performed using the interface device. In yet another aspect, the one or more external devices can comprise any conventional electronic device, such as, for example and without limitation, a conventional personal digital assistant (PDA), a conventional cellular phone equipped with data receiving/transmission capabilities, and another conventional interface device, such as, for example and without limitation, a computer mouse.

It is contemplated that the means for transmitting information 42 can comprise at least one of a universal serial bus (USB) port, a wireless communications port, or other conventional data communications port. As depicted in FIG. 6, it is further contemplated that the means for transmitting information 42 can comprise a USB cable or other conventional data communications cable. In one aspect, the means for transmitting information 42 can be attached to an external surface of the support housing 12 as depicted in FIG. 3. In this aspect, the means for transmitting information 42 can optionally be detachable from the support housing 12. In another aspect, the means for transmitting information 42 can be configured to receive selected information from the one or more external devices to which the interface device 10 is connected. In this aspect, the selected information can comprise at least one of the following: selected output signals of the at least one pressure sensor 30; audible response data; device configuration data; and device performance data. It is contemplated that the audible response data stored on the memory can comprise one or more audio tracks. It is further contemplated that the device configuration data can comprise information regarding user-controlled performance specifications. It is still further contemplated that the device performance data stored on the memory can comprise information regarding the performance of the interface device 10. In one aspect, it is contemplated that the interface device 10 and the one or more external devices can function together as an electronic interface system.

As depicted in FIG. 10, it is contemplated that the processor 34 can be selectively configured to perform steps that control the operation of the interface device 10. In one aspect, the processor 34 can be configured to instruct each pressure sensor 30 of the at least one pressure sensor to substantially instantaneously generate a pressure signal. In another aspect, the processor 34 can be configured to analyze the pressure signals generated by the at least one pressure sensor 30 and to perform a corresponding device operation. In one aspect, the device operation can comprise disregarding pressure signals from the at least one pressure sensor 30 if the pressure signals are below a predetermined pressure value. In an additional aspect, the device operation can comprise displaying an output signal corresponding to a pressure signal on the visual display means 36. In another aspect, the device operation can comprise generating a predetermined audible response corresponding to a pressure signal from the at least one pressure sensor 30. In yet another aspect, the device operation can comprise transmitting an output signal corresponding to a pressure signal of the at least one pressure sensor 30 to one or more external devices using the means for transmitting information 42 disclosed herein. In a further aspect, the device operation can comprise storing an output signal corresponding to a pressure signal of the at least one pressure signal in the memory of the interface device 10. In this aspect, the device operation can further comprise transmitting stored output signals from the memory to one or more external devices using the means for transmitting information 42 disclosed herein. In still a further aspect, the device operation can comprise processing information received from an external device as described herein. In this aspect, the information received from the external device can comprise at least one of audio response data and device configuration data.

In a further aspect, and with reference to FIG. 5, the interface device 10 can comprise a power source 44 which can be in electrical communication with the processing circuitry 32. In one aspect, the power source 44 can be positioned within the inner chamber 18 of the support housing 12 and comprise one or more conventional batteries. However, it is contemplated that any conventional power generation means can be used as the power source 44. It is further contemplated that the support housing can define a removable access door 17 for permitting external access to the power source 44 for replacement of the batteries. In another aspect, the processing circuitry 32 can comprise means for sensing when the interface device 10 is connected to an external device. In this aspect, the processing circuitry 32 can be configured to electrically isolate the power source 44 when the interface device 10 is connected to an external device. It is contemplated that the interface device 10 can be powered by the external device during periods when the interface device is electrically connected to the external device. In a further aspect, the interface device 10 can comprise a conventional electronic power supply, including, for example and without limitation, an alternating current power supply. In this aspect, the electronic power supply can be configured for placement in electrical communication with the processing circuitry 32. In still a further aspect, the interface device 10 can comprise a conventional on/off switch in communication with the power source 44 configured to permit selective control of the supply of power to the interface device. It is contemplated that the on/off switch can be on an external portion of the support housing.

In use, the interface device as described herein permits electrical communication with one or more external devices through various methods. In one aspect, a method for electrically communicating with one or more external devices comprises providing an interface device as described herein. In another aspect, the method for electrically communicating with one or more external devices comprises selectively applying a force at an origin position relative to the contact surface of the body of the interface device. In this aspect, the force can be selectively applied at the origin position such that the operation of at least one application stored on a memory of the one or more external devices is adjusted. For example, the at least one application can be configured to receive an output signal from the processing circuitry and to perform a corresponding action within each respective application. It is contemplated that the at least one application can comprise, for example and without limitation, a game application, a computer aided design (CAD) application, a computer art design application, and the like. Flowcharts depicting exemplary uses of the interface device are provided in FIGS. 7 and 8.

### EXAMPLES

The interface devices and systems disclosed herein can be used in a variety of interactive applications. For example, the interface device can be used as a force measurement game. In this example, a user can smash the contact surface of the body with the goal of applying the greatest possible force to the contact surface. The processor can process the resultant pressure signals to produce an output signal indicative of the magnitude of the force applied by the user. Based upon the output signal, the processor can direct the visual display means to graphically display a representation the strength of the user. In addition, the processor can direct the sound generating means to produce an audible response corresponding to the level of strength exhibited by the user. It is contemplated that these functions can also be performed by external devices as disclosed herein.

In another example, the interface device can be placed in electrical communication with a personal computer or gaming console. In this example, the interface device can cooperate with a keyboard or other accessory to function as a game controller. The keyboard or other accessory item can be used to control directional movement during the course of the game. A user can concurrently apply a force to the contact surface at a desired magnitude so as to control the magnitude of an action required by the game, such as, for example and without limitation, the velocity of a projectile.

In other gaming examples, the interface device can be used to control both two-dimensional movement during the course of a game and the magnitude of an action required by the game. For example, a user can move his or her finger(s) across the contact surface to control the movement of a game character or item, and the user can apply a force to the contact surface so as to control the magnitude of an action to be completed by the game character or item during the course of the game, such as, for example and without limitation, accelerating, stopping, swinging, throwing, and the like.

In a further example, the interface device can be used to interact with a CAD application. In this example, the interface can be placed in electrical communication with a personal computer running the CAD application. When the CAD application is running, a user can move his or her finger(s) across the contact surface to control movement of a cursor on a visual display means in communication with the personal computer. The user can also apply a selected force to the contact surface to control the degree to which a selected modeling tool is virtually applied to a CAD model within the CAD application.

In still a further example, the interface device can be used to interact with a computer art design application. In this example, the interface can be placed in electrical communication with a personal computer running the computer art design application. When the computer art design application is running, a user can move his or her finger(s) across the contact surface to control movement of a cursor on a visual display means in communication with the personal computer. The user can also apply a selected force to the contact surface to control the magnitude of a virtual effect that is applied to a computerized work, such as, for example and without limitation, the size of a paintbrush or the opacity of a color.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

1. An interface device for measuring a force applied to at least a portion thereof, the
interface device comprising:
a support housing,
a body positioned on the support housing, the body being deformable along at least a portion thereof, with the deformable portion of the body defining a chamber, the body comprising:
an outer surface defining thereon a contact surface for receiving the force; and
a fluid medium disposed within the chamber of the body;
at least one pressure sensor in communication with the fluid medium, wherein the at least one pressure sensor is configured to produce a pressure signal indicative of pressure created by application of the force upon the contact surface;
processing circuitry configured to receive the pressure signal and produce an output signal; and
means for communicating the pressure signal to the processing circuitry.

2. The interface device of claim 1, wherein the fluid medium within the chamber comprises a gelatinous material having a viscosity ranging from about 1 to about 500 milliPascal-seconds.

3. The interface device of claim 1, wherein each pressure sensor of the at least one pressure sensor has a resolution of less than about 70 kiliPascals.

4. The interface device of claim 1, wherein at least a portion of each pressure sensor of the at least one pressure sensor is disposed within the chamber.

5. The interface device of claim 1, wherein the at least one pressure sensor comprises a plurality of pressure sensors, wherein the outer surface of the body defines a plurality of openings, and wherein at least one pressure sensor of the plurality of pressure sensors is received within an opening of the plurality of openings in the outer surface.

6. The interface device of claim 1, wherein the support housing has a recessed portion, and wherein at least a portion of the body is positioned within the recessed portion of the support housing.

7. The interface device of claim 1, wherein the support housing defines an inner chamber.

8. The interface device of claim 7, wherein the processing circuitry is positioned within the inner chamber of the support housing.

9. The interface device of claim 1, wherein the processing circuitry comprises a processor, wherein the force is applied at an origin position relative to the contact surface of the body, and wherein the processor is configured to identify the origin position of the force.

10. The interface device of claim 9, wherein the processor is configured to produce an array of output signals corresponding to the pressure signals measured by the at least one pressure sensor, and wherein the processor is configured to calculate two-dimensional coordinates corresponding to the origin position of the force relative to the contact surface of the body.

11. The interface device of claim 1, wherein the interface device further comprises visual display means, wherein the visual display means is in electrical communication with the processing circuitry, and wherein the visual display means is configured to display the output signal of the at least one pressure sensor.

12. The interface device of claim 1, wherein the interface device further comprises sound generating means, wherein the sound generating means is in electrical communication with the processing circuitry, and wherein the sound generating means is configured to generate an audible response corresponding to the output signal of the at least one pressure sensor.

13. The interface device of claim 1, wherein the interface device further comprises a memory, wherein the memory is in electrical communication with the processing circuitry, and wherein the memory is configured to store at least one of selected output signals of the at least one pressure sensor, audible response data, device configuration data, and device performance data.

14. The interface device of claim 1, wherein the processing circuitry comprises means for transmitting information to, and receiving information from, one or more external devices, wherein the means for transmitting information is configured to transmit selected output signals of the at least one pressure sensor to the one or more external devices, and wherein the one or more external devices comprises at least one of a personal computer and a gaming console.

15. An electronic interface system comprising:
an interface device for measuring a force applied to at least a portion thereof, the interface device comprising:
a support housing,
a body positioned on the support housing, the body being deformable along at least a portion thereof, with the deformable portion of the body defining a central chamber, the body comprising:
an outer surface defining thereon a contact surface for receiving the force; and
a fluid medium disposed within the central chamber of the body;
at least one pressure sensor in communication with the fluid medium, wherein the at least one pressure sensor is configured to produce a pressure signal indicative of pressure created by application of the force upon the contact surface at an origin position;
processing circuitry comprising a processor, wherein the processing circuitry is configured to receive the pressure signal, wherein the processor is configured produce an output signal corresponding to the pressure signal measured by the at least one pressure sensor, and wherein the processor is configured to calculate two-dimensional coordinates corresponding to the origin position of the force relative to the contact surface of the body; and
means for communicating the pressure signal to the processing circuitry; and
one or more external devices, wherein the one or more external devices are in electrical communication with the processing circuitry of the interface device, and wherein the one or more external devices are configured to transmit information to, and receive information from, the processing circuitry.

16. The electronic interface system of claim 15, wherein the one or more external devices comprises at least one of a personal computer, a gaming console, and a visual display means.

17. A method for electrically communicating with one or more external devices, the method comprising:
providing an interface device for measuring a force applied to at least a portion thereof, the interface device comprising:
a support housing,
a body positioned on the support housing, the body being deformable along at least a portion thereof, with the deformable portion of the body defining a central chamber, the body comprising:
an outer surface defining thereon a contact surface; and
a fluid medium disposed within the central chamber of the body;
at least one pressure sensor in communication with the fluid medium;
processing circuitry comprising a processor, wherein the processing circuitry is in electrical communication with the at least one pressure sensor; and
selectively applying the force at an origin position relative to the contact surface of the body of the interface device,
wherein the at least one pressure sensor is configured to produce a pressure signal indicative of pressure created by application of the force upon the contact surface, wherein the processor is configured to produce an output signal corresponding to the pressure signal measured by the at least one pressure sensor, and wherein the processor is configured to calculate two-dimensional coordinates corresponding to the origin position of the force relative to the contact surface of the body.

18. The method of claim 17, wherein the processing circuitry of the interface device is in electrical communication with the one or more external devices, and wherein the processing circuitry is configured to transmit information to, and receive information from, the one or more external devices.

19. The method of claim 18, wherein the one or more external devices comprises at least one of a personal computer, a gaming console, and a visual display means.

20. The method of claim 19, wherein the force is selectively applied at the origin position such that the operation of at least one application stored on a memory of the one or more external devices is adjusted.

21. An interface device for measuring a force applied to at least a portion thereof, the interface device comprising:
a support housing,
a body positioned on the support housing, the body being deformable along at least a portion thereof, with the deformable portion of the body defining a chamber, the body comprising:
an outer surface defining thereon a contact surface for receiving the force; and
a fluid medium disposed within the chamber of the body;
at least one pressure sensor in communication with the fluid medium, wherein the at least one pressure sensor is configured to produce a pressure signal indicative of pressure created by application of the force upon the contact surface; and
processing circuitry that is in operative communication with the pressure sensor to thereby electrically communicate the pressure signal to the processing circuitry, and wherein the processing circuitry produces an output signal in response to the pressure signal.

22. The interface device of claim 21, wherein the fluid medium within the central chamber comprises a gelatinous material having a viscosity ranging from about 1 to about 500 milliPascal-seconds.

23. The interface device of claim 21, wherein each pressure sensor of the at least one pressure sensor has a resolution of less than about 70 kiliPascals.

24. The interface device of claim 21, wherein at least a portion of each pressure sensor of the at least one pressure sensor is disposed within the chamber.

25. The interface device of claim 21, wherein the at least one pressure sensor comprises a plurality of pressure sensors.

26. The interface device of claim 21, wherein the processing circuitry comprises a processor, wherein the force is applied at an origin position relative to the contact surface of the body, and wherein the processor is configured to identify the origin position of the force.

27. The interface device of claim 26, wherein the processor is configured to produce an array of output signals corresponding to the pressure signals measured by the at least one pressure sensor, and wherein the processor is configured to calculate two-dimensional coordinates corresponding to the origin position of the force relative to the contact surface of the body.

28. The interface device of claim 21, wherein the interface device further comprises a memory, wherein the memory is in electrical communication with the processing circuitry, and wherein the memory is configured to store at least one of selected output signals of the at least one pressure sensor, audible response data, device configuration data, and device performance data.
